(19) United States
(12) Patent Application Publication
(10) Pub. No.: US 2017/0173687 A1
(43) Pub. Date: Jun. 22, 2017

(54) Method And Arrangement For Improving Heat Transfer For Tundish Plasma Heating

(71) Applicant: ABB Technology Ltd, Zurich (CH)

(72) Inventors: Emmanuel Abiona, Vasteras (SE); Hongliang Yang, Vasteras (SE); Jan-Erik Eriksson, Vasteras (SE)

(21) Appl. No.: 14/978,521

(22) Filed: Dec. 22, 2015

(51) Int. Cl. B22D 41/015; F27D 11/08; H05H 1/26; F27D 99/00; B22D 11/00; F27D 27/00; F27D 1/00

(52) U.S. Cl. CPC B22D 41/015; F27D 27/00; F27D 11/08; F27D 1/00; F27D 99/0006; B22D 11/00; H05H 1/26; F27D 2099/0031

(57) ABSTRACT

An arrangement for heat transfer to a melt in a tundish in a continuous casting process, wherein the tundish includes at least one outlet and an inlet, the arrangement including a heating chamber, a plasma heating apparatus including a plasma torch positioned inside the heating chamber, wherein the plasma heating apparatus is mounted on an arm and arranged to operate through a hole in the heating chamber with a distance to the melt and an electromagnetic stirrer placed outside of the heating chamber and arranged to electromagnetically stir the melt. The heating chamber further includes a pair of weirs installed at an upper part of the heating chamber and a pair of dams installed at a lower part of the heating chamber and the electromagnetic stirrer is arranged to electromagnetically stir the melt in a region of the heating chamber, wherein the region is enclosed by the weirs and dams.

### FIELD OF THE INVENTION

The present invention relates to a method and an arrangement device for improving a tundish plasma heating transferring, wherein the tundish comprises an outlet and a ladle having an inlet, the arrangement comprising a heating chamber including a pair of weirs installed upper part of the heating chamber and a pair of dams installed lower part of the heating chamber and, a plasma heating apparatus mounted on the heating chamber with a distance to the melt.

### BACKGROUND OF THE INVENTION

Tundish plasma heating is used in a continuous casting of metal for accurately controlling the casting temperature variation of a molten metal in a tundish. Tundish plasma heating applies a plasma torch to transfer the heat direct to the melt surface of the tundish, which is in turn transported into the melt by designed fluid flow. The plasma torch is housed in the tundish for generating plasma arcs and operates during casting at a controlled current with a max current of about 5000 Amp, and also requires a certain argon flowrate to form the plasma arc. The tundish is covered with a high grade refractory lid and thus forms a heating chamber, which establishes an inert atmosphere above the molten metal protecting it against re-oxidation and nitrogen pick-up. The surface area in the heating chamber shall be slag free to ensure the current circuit of plasma.

A normal temperature of plasma arcs is about 10000° C. This heat is transferred from the plasm arc and radiated within a heating chamber so that the temperature of the melt surface is increased to a higher level. The high temperature of the melt surface results in a high temperature gradient in the upper part of the heat chamber, which in turn results in a big buoyancy force. The buoyancy force counteracts a convective flow coming from an inlet stream, thus a stagnant zone in the upper part of the heating chamber is formed. The stagnant zone thus results in a low heat transfer rate from the top to the bottom of the heating chamber. This means that a main drawback with plasma heating is its low heating efficiency, normally only about 60% of heating can be utilized.

JP04089160 discloses a system, in which a molten steel is poured in a tundish from a ladle through a nozzle and further from a tundish nozzle to a mold. The system further comprises a plasma heating device placed between the ladle nozzle and the tundish nozzle for heating the molten steel and a molten steel stirring device placed near the plasma heating device for stirring the molten steel with electromagnetic force. An AC linear motor electromagnetic coil or an electric magnet is used to the molten steel stirring device.

### SUMMARY OF THE INVENTION

The object of the present invention is to provide a method for improving heat transfer efficiency of a melt in a tundish in a continuous casting process.

In a first aspect of the invention, there is a method for improving the heat transfer of a melt in a tundish in a continuous casting process. The method comprises mounting a plasma heating device with a plasma torch inside a heating chamber, wherein the heating chamber is positioned above the tundish with a distance to the melt, installing a pair of weirs at an upper part of the heating chamber, installing a pair of dams at an lower part of the heating chamber, mounting an electromagnetic stirrer on an outer surface of the tundish for electromagnetically stirring the melt, applying plasma heating to the melt inside of the tundish through a heating chamber, and electromagnetically stirring the melt in a region of the heating chamber, wherein the region is enclosed by the weirs and dams.

The electromagnetic stirring establishes a stirring force along the tundish wall, the stirring force agitates a rotational flow inside the heating chamber, which in turn homogenizes the temperature and improves the heat transfer from the plasma torch to the melt. The melt may be electromagnetically stirred in a direction either upward or downward with respect to an axis.

Since only the region surrounded by the dams and weirs is electromagnetically stirred, shortcutting flow from the heating chamber to outlets of the tundish is therefore prevented.

It is advantageous to apply electromagnetically stirring since the stirrer has no contact with tundish melt, and can be operated independently, thus a better reliability is achieved.

Moreover, since the melt flow in the tundish cab be controlled with a constant flow pattern, irrespective the melt temperature or the refractory conditions, a superior repeatability is achieved.

Further advantages include
maintaining a stable free surface of the melt, thus the stability of plasma arcs is not affected.
moving a possible slag of the melt surface away from the plasma heating area.
controlling melt flow in desired characteristics; minimizing a dead zone; achieving strong and larger mixing volume.

According to one embodiment of the invention, the method further comprises controlling a stirring speed of the electromagnetically stirring in a range of 0.2-0.5 m/sec to establish a similar rotational flow speed of melt.

In a second aspect, there is an arrangement provided for heat transfer of a melt in a tundish in a continuous casting process, wherein the tundish comprises an outlet and an inlet. The arrangement comprises a heating chamber, a plasma heating apparatus (30) comprising a plasma torch (32) positioned inside the heating chamber, wherein the plasma heating apparatus (30) is mounted on an arm and arranged to be operated through a hole in the heating chamber (20) with a distance to the melt (60) and an electromagnetic stirrer placed outside of the heating chamber. The heating chamber further comprises a pair of weirs installed at an upper part of the heating chamber and a pair of dams installed at a lower part of the heating chamber and the electromagnetic stirrer is arranged to electromagnetically stir the melt in a region of the heating chamber, wherein the region is enclosed by the weirs and dams.

In a first embodiment of the invention, the dams and weirs are placed between the inlet and an outlet of the tundish.

In a third aspect, there is a tundish provided for continuous casting a melt comprising an arrangement of the present invention. The tundish may be a multi-strand tundish including a second outlet.

### BRIEF DESCRIPTION OF THE DRAWINGS

The invention will now be explained more closely by the description of different embodiments of the invention and with reference to the appended figures.

FIG. 1a shows a flowchart of improving a heat transfer of a melt in a tundish in a continuous casting process, according to one embodiment of the invention.

FIG. 1b shows a flowchart of improving a heat transfer of a melt in a tundish in a continuous casting process, according to another embodiment of the invention.

FIGS. 2a-c illustrate a system schematic top view, a side and front views of an arrangement for heat transferring of a melt in a tundish in a continuous casting process, according to a third embodiment of the invention.

FIG. 3 illustrates velocity fields of a tundish in different configuration, particularly arrangements without an electromagnetic stirring and an arrangement of the embodiment of FIGS. 2a-c.

### DETAILED DESCRIPTION OF THE INVENTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art.

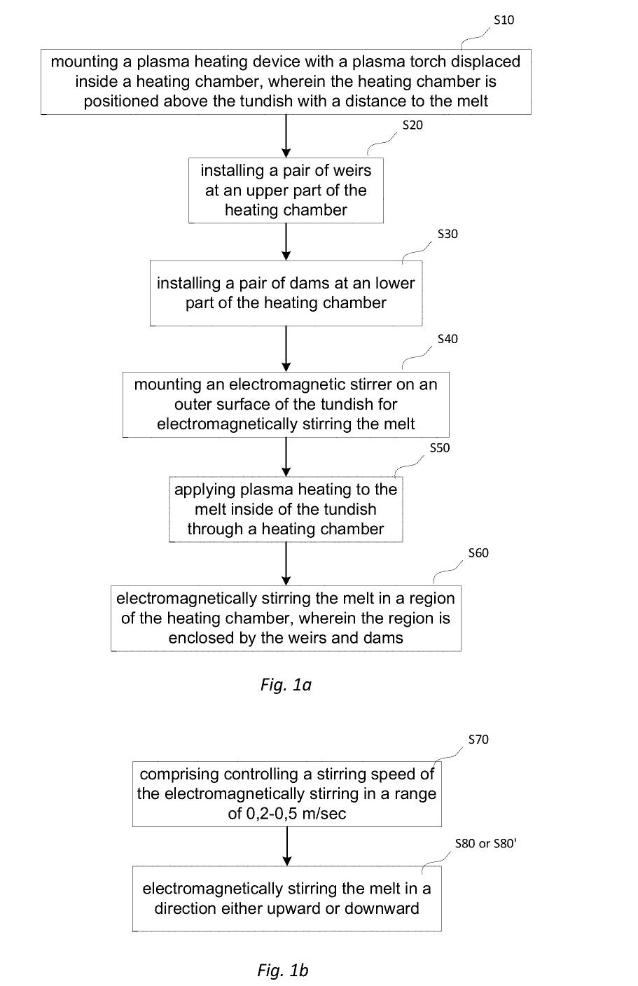

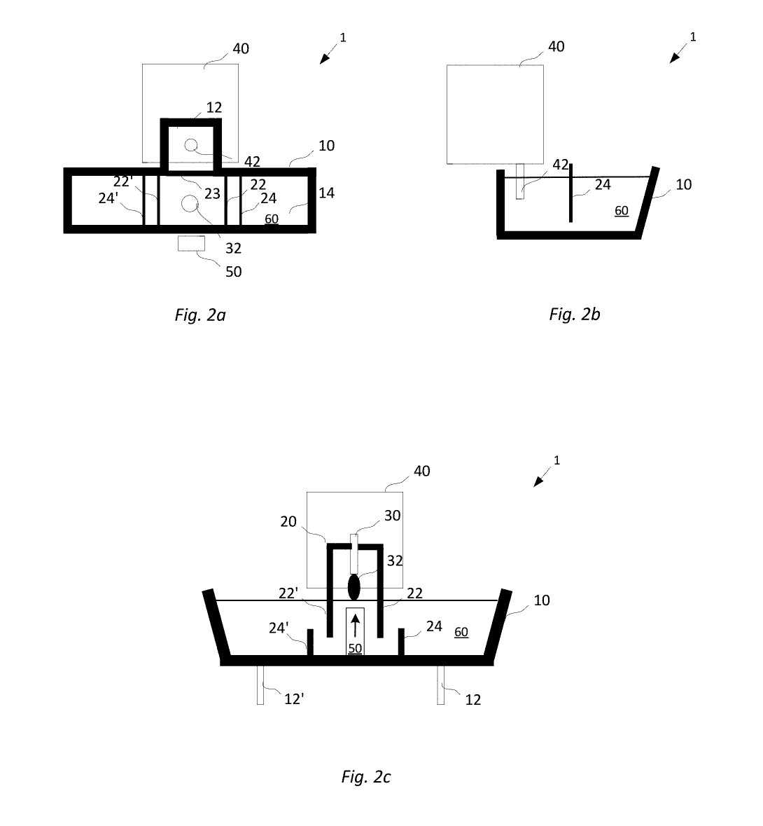

With reference to FIGS. 2a-c and FIG. 1a-b, an arrangement 1 of the present invention for heat transferring of a melt 60 in a tundish including a mould 10 in a continuous casting process. The tundish 10 further comprises an outlet also denoted as tundish nozzle 12. In this example, two outlets 12, 12′, denoted tundish nozzles, are arranged at each side of the tundish. A ladle 40 including an inlet 42 is arranged for supplying the melt into the tundish. The tundish 10 is arranged for connecting the ladle 40 and a continuous caster and, as a reservoir, it continuously distributes and supplies the melt to a caster. To be able to provide a high quality of a metal, the tundish 10 provides the melt 60 to the continuous caster at a desired temperature degree and at a uniform flow rate. The melt 60, i.e. molten metal may be any of iron, steel, aluminium, cooper, and alloys or a mixture of the above.

In this exemplary embodiment, the tundish 10 is a T-shaped tundish being divided into two parts, an inlet chamber 12 and an outlet chamber 14 and has a weight of 30 ton. The outlet chamber is essentially the arm part of the T-shape and has a rectangle form. The inlet chamber 12 is essentially the central leg part of the T-shape so it is positioned directly at one side of the longer sides of the outlet chamber 14 while ladle 40 is positioned above the inlet chamber 12 that receives the melt transported from the ladle 40 through its inlet 42.

The arrangement 1 comprises a heating chamber 20 that partly is made of a high grade refractory lid, a plasma heating apparatus 30 mounted on the heating chamber with a distance to the melt and an electromagnetic stirrer 50. The heating chamber 20 establishes an inert atmosphere above the molten metal protecting it against re-oxidation and nitrogen pick-up. In this exemplary embodiment, the heating chamber is positioned above the outlet chamber 14.

The plasma heating apparatus 30 is being mounted on the heating chamber 20 with a distance to the melt surface and between the ladle inlet 42 and the outlets 12, 12′ of the tundish, step, S10. The plasma heating apparatus 30 including a plasma burner that produces a plasma torch (32) is arranged for heating the melt 60.

The heating chamber 20 further includes a pair of weirs 22, 22′ installed at an upper part of the heating chamber and a pair of dams 24, 24′ installed at a lower part of the heating chamber, step S20 and S30. The arrangement of weirs 22, 22′ further encloses the heating chamber for plasma heating to ensure efficient plasma heating to prevent slag from the heating chamber and seal the heating chamber with argon gas to avoid re-oxidation of the melt and to maintain the plasma arc. The dams 24, 24′ increases a mixing of the melt and enables one rotational flow in the heating chamber. Furthermore, the arrangement of the dams 24, 24′ prevents a shortcut flow from the heating chamber to the outlets 12, 12′. In this exemplary embodiment, a further third weir 23 is arranged between the inlet chamber 12 and the outlet chamber 14.

The electromagnetic stirrer 50 is placed outside of the tundish, in this example, on the outer surface of another side of the longer sides of the outlet chamber 14, step 40. It is arranged to electromagnetically stir the melt in the region enclosed by the weirs 22, 22′, 23 and dams 24, 24′ using electromagnetic force, step S50 when plasma heat is applied to the melt inside of the tundish, step 40. This is because that the heat transfer between plasma torch and melt happens mainly in the heating chamber, Stirring outside the heating chamber will not be efficient to promote heat transfer. Preferably, the stirring speed of the electromagnetically stirring is controlled in a range of 0.2-0.5 meter/second, step S70, in order to homogenize the temperature in the heating chamber, and at the same time avoid strong turbulence in the heating chamber. The stirring speed is based on the numerical simulation, and shall be fine-tuned based the quality feedback of the continuous casting process. The minimum stirring speed limit ensures a mixing effect in the heating chamber, while the maximum stirring speed limit prevents a strong turbulence in the heating chamber and slag entrapment into the melt. For a tundish without top slag, it is possible with a stirring speed higher than 0.5 m/sec.

Furthermore, the electromagnetic stirrer 50 is arranged to electromagnetically stir the melt in either upward or downward direction, step S80 or S80′ so that either upward or downward stirring force is created along inside walls of the tundish, in this example, the melt is stirred in a upward direction as shown in FIG. 2c, which causes the melt in the tundish flows upwards so that low temperature melt is rotated up to the surface of the melt above which the plasma torch is located to be heated uniformly. This in turn homogenizes the temperature of the melt and improves the heat transfer from the plasma arc to the melt.

It should be understood that although the exemplary embodiment of FIGS. 2a-c show a T-shaped multi-strand tundish, the invention is applicable to a single strand tundish as well or another shaped single or multi-strand tundish as well, for example, L- or C- or H-shaped.

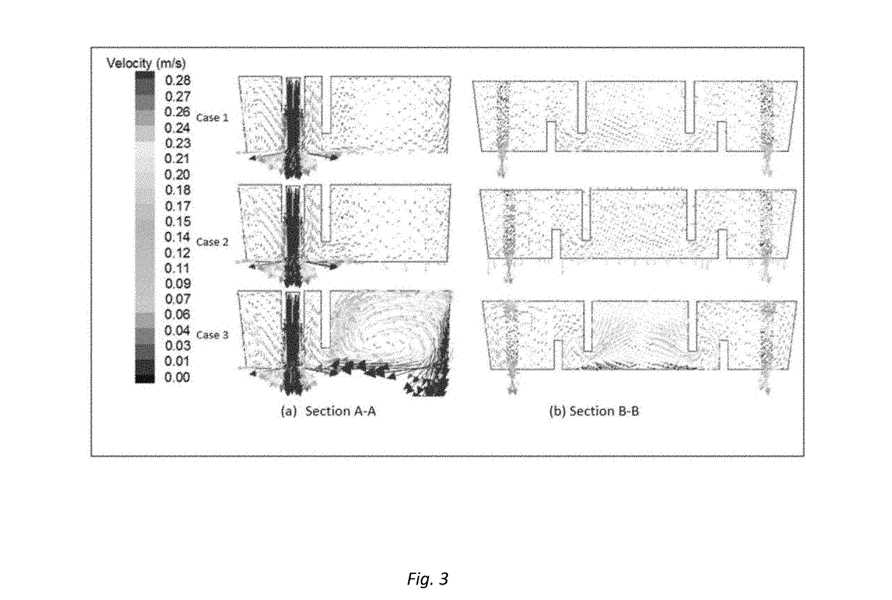

Combining an electromagnetically stirring with plasma heating, a rotational flow, i.e. a heat transferring efficiency is largely improved, which is evident by simulations as shown in FIG. 3, wherein different configurations are compared.

FIG. 3 illustrates simulated velocity fields of a tundish in different configuration, particularly arrangements without an electromagnetic stirring and an arrangement of the embodiment of FIGS. 2a-c.

The following table presents different simulated configurations of plasma heating and electromagnetic stirring.

| | Plasma heating | Electromagnetic stirring |
|---|---|---|
| Case 1 | No | No |
| Case 2 | Yes | No |
| Case 3 | Yes | Yes |

In the first case, a configuration without a plasma heating and electromagnetic stirring is simulated, wherein a weak rotational flow in the heating chamber is presented. In the second case, a configuration with plasma heating but without electromagnetic stirring is simulated, a moderate the rotational flow in the heating chamber is presented. In the third case, a configuration with both a plasma heating and electromagnetic stirring is simulated, a strong rotational flow is presented in the heating chamber.

1. A method for improving a heat transfer of a melt in a tundish in a continuous casting process, comprising:
mounting a plasma heating device with a plasma torch positioned inside a heating chamber, wherein the heating chamber is positioned above the tundish with a distance to the melt,
installing a pair of weirs at an upper part of the heating chamber,
installing a pair of dams at an lower part of the heating chamber,
mounting an electromagnetic stirrer on an outer surface of the tundish for electromagnetically stirring the melt,
applying plasma heating to the melt inside of the tundish through a heating chamber, and
electromagnetically stirring the melt in a region of the heating chamber, wherein the region is enclosed by the weirs and dams.

2. The method according to claim 1 further comprising controlling a stirring speed of the electromagnetically stirring in a range of 0.2-0.5 m/sec.

3. The method according to claim 1 further comprising controlling a stirring speed of the electromagnetically stirring higher than 0.5 m/sec.

4. The method according to claim 1 further comprising electromagnetically stirring the melt in a direction either upward or downward.

5. An arrangement for heat transfer to a melt in a tundish in a continuous casting process, wherein the tundish comprises at least one outlet and an inlet, the arrangement comprising:
a heating chamber,
a plasma heating apparatus comprising a plasma torch positioned inside the heating chamber, wherein the plasma heating apparatus is mounted on an arm and arranged to be operated through a hole in the heating chamber with a distance to the melt and,
an electromagnetic stirrer placed outside of the heating chamber and arranged to electromagnetically stir the melt,
characterized in that the heating chamber further comprises a pair of weirs installed at an upper part of the heating chamber and a pair of dams installed at a lower part of the heating chamber and the electromagnetic stirrer is arranged to electromagnetically stir the melt in a region of the heating chamber, wherein the region is enclosed by the weirs and dams.

6. The arrangement of claim 5, wherein the electromagnetic stirrer is arranged to stir the melt at stirring speed in a range of 0.2-0.5 m/sec.

7. The arrangement of claim 5, wherein the electromagnetic stirrer is arranged to stir the melt at stirring speed higher than 0.5 m/sec.

8. The arrangement of claim 5, wherein the dams and weirs are placed between the inlet of the ladle and an outlet of the tundish.

9. The arrangement of claim 5, wherein the electromagnetic stirrer is arranged to stir the melt in either upward or downward direction.

10. A tundish for continuous casting a melt comprising:
a heating chamber,
a plasma heating apparatus having a plasma torch positioned inside the heating chamber, wherein the plasma heating apparatus is mounted on an arm and arranged to be operated through a hole in the heating chamber with a distance to the melt and,
an electromagnetic stirrer placed outside of the heating chamber and arranged to electromagnetically stir the melt,
characterized in that the heating chamber further comprises a pair of weirs installed at an upper part of the heating chamber and a pair of dams installed at a lower part of the heating chamber and the electromagnetic stirrer is arranged to electromagnetically stir the melt in a region of the heating chamber, wherein the region is enclosed by the weirs and dams.

11. The tundish of claim 10 is a multi-strand tundish with two or more outlets.
